(19) United States
(12) Patent Application Publication
(10) Pub. No.: US 2025/0371275 A1
(43) Pub. Date: Dec. 4, 2025

(54) TEXT GENERATION METHOD AND APPARATUS, DEVICE, AND STORAGE MEDIUM

(71) Applicant: Beijing Zitiao Network Technology Co., Ltd., Beijing (CN)

(72) Inventors: Cheng Zhao, Beijing (CN); Xiaocheng Li, Beijing (CN); Zhen Wang, Beijing (CN)

(21) Appl. No.: 19/201,566

(22) Filed: May 7, 2025

(30) Foreign Application Priority Data
May 30, 2024 (CN) 202410693352.3

(51) Int. Cl. G06F 40/30; G06N 20/00

(52) U.S. Cl. CPC G06F 40/30; G06N 20/00

(57) ABSTRACT

The present disclosure provides a text generation method and apparatus, a device, and a storage medium. The text generation method includes: obtaining text information to be processed; and inputting the text information to be processed to a text generation model to obtain target text information corresponding to the text information to be processed, the target text information is determined by splicing the N pieces of sub-text information in a preset order, with a literary feature of the target text information meeting a preset condition; first sub-text information of the target text information is determined by the text generation model according to a semantic feature of the text information to be processed; and i-th sub-text information of the target text information is determined by the text generation model according to literary features of the first sub-text information to (i−1)-th sub-text information.

### CROSS-REFERENCE TO RELATED APPLICATION

The present application claims priority of the Chinese Patent Application No. 202410693352.3, filed on May 30, 2024, the disclosure of which is incorporated herein by reference in the present application.

### TECHNICAL FIELD

Embodiments of the present disclosure relate to the field of the computer technology, and in particular, to a text generation method and apparatus, a device, and a storage medium.

### BACKGROUND

In the context of rapid development of the deep learning technology, it is still difficult to generate high levels of literary works (such as poems and Ci, couplets, fictions, and proses) by a deep learning model. The quality of the generated literary works cannot be guaranteed.

### SUMMARY

Embodiments of the present disclosure provide a text generation method and apparatus, a device, and a storage medium, which can improve quality of text generation.

In a first aspect, the embodiments of the present disclosure provide a text generation method, which includes:
obtaining text information to be processed; and
inputting the text information to be processed to a text generation model to obtain target text information corresponding to the text information to be processed, the target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;
first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

In a second aspect, the embodiments of the present disclosure further provide a text generation apparatus, which includes:

a text-information-to-be-processed obtaining module configured to obtain text information to be processed; and

a target text information obtaining module configured to input the text information to be processed to a text generation model to obtain target text information corresponding to the text information to be processed, the target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;

first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

In a third aspect, the embodiments of the present disclosure further provide an electronic device, which includes:
one or more processors; and
a storage apparatus configured to store one or more programs,
the one or more programs, when executed by the one or more processors, cause the one or more processors to implement the text generation method according to the embodiments of the present disclosure.

In a fourth aspect, the embodiments of the present disclosure further provide a storage medium including computer-executable instructions, the computer-executable instructions, when executed by a computer processor, are configured to perform the text generation method according to the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of a text generation method provided by embodiments of the present disclosure;

FIG. 2 is a schematic diagram of training a first evaluation model and a second evaluation model provided by embodiments of the present disclosure;

FIG. 3 is a schematic diagram of training a text information generation model provided by embodiments of the present disclosure;

FIG. 4 is a flowchart of generating target text information provided by embodiments of the present disclosure;

FIG. 5 is a diagram illustrating an example of a text generation process provided by embodiments of the present disclosure;

FIG. 6 is a structural schematic diagram of a text generation apparatus provided by embodiments of the present disclosure; and

FIG. 7 is a structural schematic diagram of an electronic device provided by embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and its variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information in interaction between a plurality of apparatuses in this embodiment of present disclosure are for illustrative purposes only and are not intended to limit the scope of such messages or information.

It is to be understood that before using the technical solutions disclosed in each embodiment of the present disclosure, it is needed to inform the type, scope of use, and use scenes, etc. of the personal information involved in the present disclosure to a user and gain the authorization of the user through appropriate methods in accordance with relevant laws and regulations.

For example, when transmitting prompt information to the user in response to an active request of the user so as to clearly prompt the user, the operation requested to be executed needs to gain and use the personal information of the user. Therefore, the user can autonomously select whether to provide personal information for software or hardware such as an electronic device, an application, a server or a storage medium executing the operation of the technical solution of the present disclosure according to the prompt information.

As an optional but non-limited implementation mode, the mode of transmitting the prompt information to the user in response to receiving the active request of the user can be a popup window mode, and the prompt information can be presented in a character mode in the popup window. In addition, the popup window can also carry a selection control for the user to select “Agree” or “Disagree” to provide personal information for the electronic device.

It is to be understood that the above-mentioned processing of informing and gaining the authorization of the user is only indicative and do not limit the implementation mode of the present disclosure, and other modes that meet the relevant laws and regulations can also be applied to the implementation mode of the present disclosure.

It is to be understood that data involved in this technical solution (including but not limited to the data itself, acquisition or use of data) shall comply with the requirements of relevant laws and regulations and relevant provisions.

FIG. 1 is a flowchart of a text generation method provided by embodiments of the present disclosure. The embodiments of the present disclosure are applicable to a scenario of generating high-quality literary works (such as poems and Ci, fictions, couplets, etc.) based on a neural network model. The text generation method may be performed by a text generation apparatus that may be implemented in the form of software and/or hardware and optionally implemented by an electronic device. The electronic device may be a mobile terminal, a personal computer (PC), a server, or the like.

As shown in FIG. 1, the text generation method includes the following steps.

S110, obtaining text information to be processed.

A text to be processed may be a literary work applicable to various literary and artistic creation fields, e.g., various types of literary works such as poems and Ci, couplets, fictions, proses, etc. The text information to be processed may be used for guiding a model to generate description information of a specific type or content and thus can help the model to better understand a user's need and generate a text matching the user's need. The text information to be processed may include information such as a text type (genre), a theme, and a reference text. Exemplarily, assuming that the text to be processed is a poem or Ci, prompt information may include information such as a poem or Ci theme, a reference line of a poem, a poem or Ci style, and a poem or Ci genre. The richer the text information to be processed, the more advantageous for the model to generate a suitable text. For example, it is required to generate a five-character quatrain describing the Spring like “Good rain knows the season ( [symbol] )”, “Spring” is the theme; “five-character quatrain” is the text type; and “Good rain knows the season ( [symbol] )” is the reference line of a poem.

S120, inputting the text information to be processed to a text generation model to obtain target text information corresponding to the text information to be processed.

The target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information.

First sub-text information of the target text information is determined by the text generation model according to a semantic feature of the text information be processed; and i-th sub-text information of the target text information is determined by the text generation model according to literary features of the first sub-text information to (i−1)-th sub-text information, and 1<i≤N.

The literary rule feature may include a literary format feature and/or a literary rhythm feature. N may represent a number of sentences included in the target text information. One piece of sub-text information corresponds to one sentence. That is, the pieces of sub-text information are separated by punctuation marks in the target text information. Exemplarily, taking the quatrain in poem and Ci-poetry as an example, N=4.

The text generation model includes a text information generation model, a first evaluation model, and a second evaluation model. The three models are all obtained by retraining pre-trained models. In this embodiment, the training processes of the three models are introduced first, and then the detailed process of obtaining the target text information based on the text generation model is introduced.

Optionally, the training process of the first evaluation model and the second evaluation model includes: obtaining a first initial model which is pre-trained; obtaining a first text information set; training the first initial model with respect to a first evaluation task based on the first text information set to obtain the first evaluation model; training the first initial model with respect to a second evaluation task based on the first text information set to obtain the second evaluation model.

Each piece of first text information in the first text information set carries a real evaluation result. The first evaluation task is a task of evaluating sub-text information. The second evaluation task is a task of evaluating text information.

The first initial model may be construed as a text knowledge model which learns the basic knowledge of a certain text type. Each piece of first text information in the first text information set has the same text type. The process of obtaining the first initial model may include: firstly obtaining literary rule information of a certain literary type and a reference text, the literary rule information may include information such as rhyming dictionary and a meter; and the reference text may include poem and Ci works of the different epochs, notes on poetry and Ci-poetry, reference ancient codes and records, and the like; and then performing low-rank adaptation (LoRA) fine adjustment on a preset model based on the literary rule and the reference text such that the first initial model has the basic knowledge of the text type. For the LoRA fine adjustment technique, a reference may be made to the relevant model training technique, which is not limited here. For example, assuming that a text generation model capable of generating a seven-character regulated verse is to be trained, each piece of first text information in the first text information set is a seven-character regulated verse; the literary rule information is the rhyming dictionary and the meter of the seven-character regulated verse; and the reference text may be poems and Ci, notes on poetry and Ci-poetry, reference ancient codes and records, and the like, that are related to the seven-character meter.

The real evaluation result is used for reflecting a real matching degree between a literary feature of the first text information and a literary feature of a corresponding text type thereof.

The first text information set includes a first positive sample and a first negative sample. The first positive sample may be a collected poem or Ci of a certain text type, and the first negative sample may be obtained by performing text adjustment on the first positive sample. The manner of adjustment may be replacement of characters, changing of an order of characters, addition of characters, or deletion of characters, etc. Then, related experts tag the first positive sample and the first negative sample with respect to literary feature to represent a semantic feature, a literary format feature and a literary rhythm feature of each piece of first text information. The literary feature may be represented by a multi-dimensional vector. A real evaluation result of the first positive sample may be obtained by determining a similarity between the literary feature of the first positive sample and its own literary feature, the similarity representing a matching degree between the literary feature of the first positive sample and the literary feature of a corresponding text type thereof, i.e., 1. That is, in the first text information set, the real evaluation result of the first positive sample is 1. A real evaluation result of the first negative sample may be obtained by determining a similarity between the literary feature of the first negative sample and the literary feature of the corresponding first positive sample, the similarity representing a matching degree between the literary feature of the first negative sample and the literary feature of a corresponding text type thereof, i.e., a value of 0-1. That is, in the first text information set, the real evaluation result of the first negative sample is a value greater than or equal to 0 and less than 1.

Optionally, the process of training the first initial model with respect to the second evaluation task based on the first text information set may include: inputting each piece of first text information in the first text information set to the first initial model to obtain a predicted evaluation result set; and training the first initial model based on the predicted evaluation result set and a real evaluation result set to obtain the second evaluation model.

Each predicted evaluation result in the predicted evaluation result set is an evaluation result predicted by the first initial model for each piece of first text information. The predicted evaluation result may be a value of 0-1 to reflect a matching degree between a literary feature of the first text information predicted by the first initial model and a literary feature of a text type corresponding to the first text information set. In this embodiment, the first initial model extracts a literary feature of the first text information and predicts a matching degree between the literary feature and a literary feature of its text type to obtain a predicted evaluation result for outputting. The processing of training the first initial model based on the predicted evaluation result set and the real evaluation result set may include: determining a loss function according to the predicted evaluation result set and the real evaluation result set, and performing parameter back-adjusting on the first initial model based on the loss function to obtain the second evaluation model, such that the second evaluation model continuously learns text features of the text type corresponding to the first text information set and has the capability of determining a matching degree between a literary feature of text information and the literary feature of the text type. Exemplarily, assuming that the text type of the first text information set is a seven-character regulated verse, the second evaluation model learns a literary feature of the seven-character regulated verse, and can determine a matching degree between a literary feature of input text information and the learned literary feature of the seven-character regulated verse.

Optionally, the manner of training the first initial model with respect to the first evaluation task based on the first text information set to obtain the first evaluation model may include: splitting each piece of first text information in the first text information set to obtain a first sub-text information set; obtaining a real evaluation sub-result set corresponding to the first sub-text information set; inputting the sub-text information set to the first initial model to obtain a predicted evaluation sub-result set; and training the first initial model based on the predicted evaluation sub-result set and the real evaluation sub-result set to obtain the first evaluation model.

The manner of splitting each piece of first text information in the first text information set may include: splitting the first text information by sentence. That is, one sentence is one piece of sub-text information. The first sub-text information may also include a second positive sample and a second negative sample. The second positive sample is obtained by splitting the above-mentioned first positive sample, and the second negative sample is obtained by splitting the above-mentioned first negative sample. Similarly, the related experts tag the second positive sample and the second negative sample with respect to literary feature to represent the semantic feature, the literary format feature and the literary rhythm feature of each piece of first sub-text information. A real evaluation sub-result of the second positive sample may be obtained by determining a similarity between the literary feature of the second positive sample and its own literary feature, the similarity representing a matching degree between the literary feature of the second positive sample and a preset literary feature of a corresponding text type thereof, i.e., 1. That is, in the first sub-text information set, the real evaluation sub-result of the second positive sample is 1. A real evaluation sub-result of the second negative sample may be obtained by determining a similarity between the literary feature of the second negative sample and the literary feature of the corresponding second positive sample, the similarity representing a matching degree between the literary feature of the second negative sample and a preset literary feature of a corresponding text type thereof, i.e., a value of 0-1. That is, in the first sub-text information set, the real evaluation sub-result of the second negative sample is a value greater than or equal to 0 and less than 1.

Each predicted evaluation sub-result in the predicted evaluation sub-result set is an evaluation result predicted by the first initial model for each piece of sub-text information. The predicted evaluation sub-result may be a value of 0-1 to reflect a matching degree between a literary feature of the first sub-text information predicted by the first initial model and the preset literary feature. In this embodiment, the first initial model extracts a literary feature of the first sub-text information and predicts a matching degree between the literary feature and the preset literary feature to obtain a predicted evaluation sub-result for outputting. The process of training the first initial model based on the predicted evaluation sub-result set and the real evaluation sub-result set may include: determining a loss function according to the predicted evaluation sub-result set and the real evaluation sub-result set, and performing parameter back-adjusting on the first initial model based on the loss function to obtain the first evaluation model, such that the first evaluation model continuously learns text features of a text type corresponding to the first sub-text information set and has the capability of determining a matching degree between a literary feature of sub-text information and a literary feature of the text type. Exemplarily, assuming that the text type of the first sub-text information set is a seven-character regulated verse, the first evaluation model learns a literary feature of the seven-character regulated verse, and can determine a matching degree between a literary feature of input sub-text information and the learned literary feature of the seven-character regulated verse.

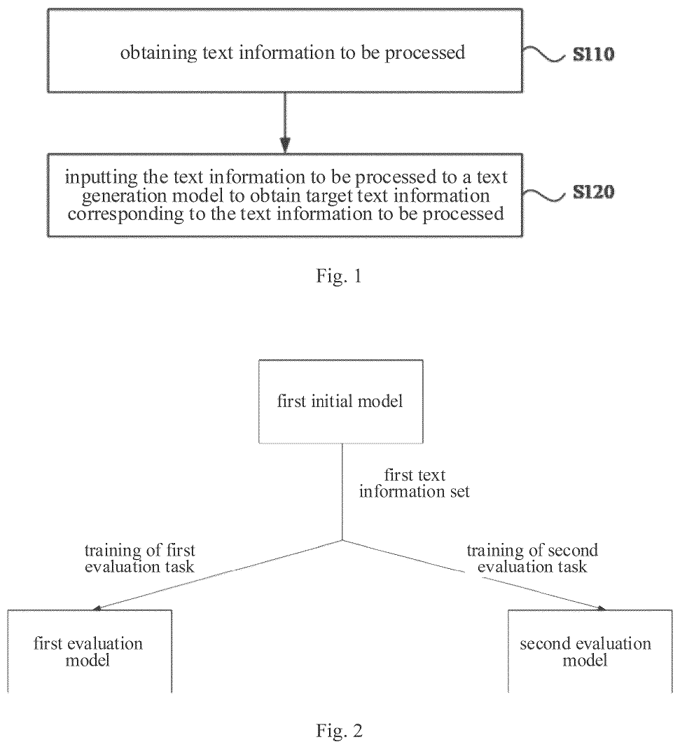

FIG. 2 is a schematic diagram of training the first evaluation model and the second evaluation model in this embodiment. As shown in FIG. 2, the first evaluation model is obtained by training the first initial model with respect to the first evaluation task based on the first text information, and the second evaluation model is obtained by training the first initial model with respect to the second evaluation task based on the first text information.

Optionally, the manner of training the text information generation model may include: obtaining a second initial model which is pre-trained; obtaining a text-information-to-be-processed set and a corresponding second text information set thereof; splitting each piece of second text information in the second text information set to obtain a second sub-text information set; and training the second initial model based on the text-information-to-be-processed set and the second sub-text information to obtain the text information generation model.

The second initial model may be a model the same as the above-mentioned first initial model. For the manner of obtaining the second initial model, a reference may be made to the manner of obtaining the first initial model in the above embodiment, which is not described redundantly here. The second text information set may be the same as the above-mentioned first text information set, and the text type of each piece of second text information in the second text information set may also be the same. For example, assuming that a text information generation model capable of generating a seven-character regulated verse is to be trained, each piece of second text information in the second text information set is a seven-character regulated verse.

In this embodiment, the manner of splitting each piece of second text information in the second text information set may include: splitting the second text information by sentence. That is, one sentence is one piece of sub-text information.

Optionally, the process of training the second initial model based on the text-information-to-be-processed set and the second sub-text information may include: for each piece of second sub-text information in the second sub-text information set, forming a text information group with the second sub-text information, preceding text information thereof, and the text information to be processed, and training the second initial model based on the text information group. The preceding text information is a preceding part of the current second sub-text information in the second text information. Exemplarily, for a four-line poem, the preceding text information of the third line is text information composed of the first and second lines; and the preceding text information of the fourth line is text information composed of the first, second and third lines.

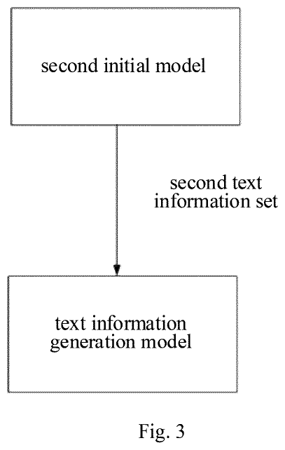

Specifically, the manner of training the second initial model based on the text information group may include: inputting the preceding text information and the text information to be processed to the second initial model, extracting, by the second initial model, a semantic feature of the text to be processed and a literary feature of the preceding text information, and obtaining predicted sub-text information for outputting according to the semantic feature of the text to be processed and the literary feature of the preceding text information; then determining a loss function according to the predicted sub-text information and the second sub-text information, and adjusting parameters in the second initial model based on the loss function to obtain the text information generation model, such that the text information generation model has the capability of generating sub-text information of the same text type with the second sub-text information set. Exemplarily, assuming that the text type of the second text information is a seven-character regulated verse, after training, the text information generation model has the capability of generating the sub-text information (lines) of a seven-character regulated verse. FIG. 3 is a schematic diagram of training the text information generation model in this embodiment. As shown in FIG. 3, the text information generation model is obtained by training the second initial model based on the second text information.

The detailed process of generating the target text information based on the text generation model is introduced below.

Different text types correspond to different text generation models. After the text information to be processed is obtained, a text type is extracted from the text information to be processed; and then the text generation model corresponding to the text type is obtained. Thus, the target text information of the corresponding text type is generated based on the text generation model. Exemplarily, assuming that the text type in the text information to be processed is a seven-character regulated verse, a text generation model corresponding to the seven-character regulated verse is obtained.

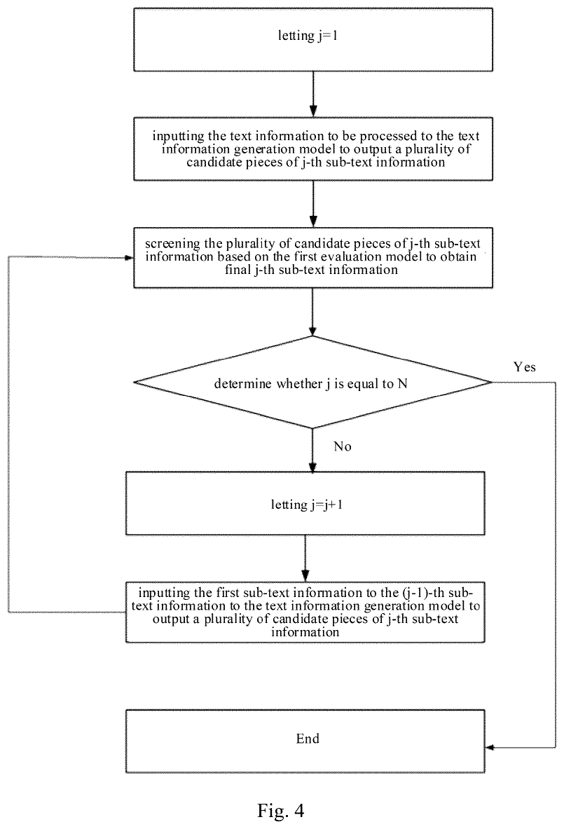

Optionally, FIG. 4 is a flowchart of generating the target text information in this embodiment. As shown in FIG. 4, the process of inputting the text information to be processed to the text generation model to obtain the target text information corresponding to the text information to be processed may include: letting j=1; inputting the text information to be processed to the text information generation model to output a plurality of candidate pieces of j-th sub-text information; screening the plurality of candidate pieces of j-th sub-text information based on the first evaluation model to obtain final j-th sub-text information; letting j=j+1, inputting the first sub-text information to the (j−1)-th sub-text information to the text information generation model to output a plurality of candidate pieces of j-th sub-text information, and performing the operation of screening the plurality of candidate pieces of j-th sub-text information based on the first evaluation model until j=N.

Optionally, the first sub-text information of the target text information is determined by the following steps: inputting the text information to be processed to the text information generation model, extracting, by the text information generation model, the semantic feature of the text information to be processed, and obtaining a plurality of candidate pieces of first sub-text information for outputting according to the semantic feature of the text information to be processed; inputting the plurality of candidate pieces of first sub-text information to the first evaluation model, separately, extracting, by the first evaluation model, literary feature of each candidate piece of first sub-text information, separately, and obtaining a plurality of first evaluation results according to the literary feature of each candidate piece of first sub-text information, and determining the first sub-text information for outputting from the plurality of candidate pieces of first sub-text information based on the plurality of first evaluation results.

The first evaluation result is used for reflecting a matching degree between the literary feature of the candidate piece of first sub-text information and a preset literary feature corresponding to the text information to be processed; and the literary feature is used for reflecting a semantic feature and/or a literary rule feature of the candidate piece of first sub-text information. Different text types correspond to different text generation models. Correspondingly, different text types correspond to different first evaluation models. Exemplarily, assuming that the text type in the text information to be processed is a seven-character regulated verse, the first evaluation model corresponding to the seven-character regulated verse is obtained.

The preset literary feature corresponding to the text information to be processed may be construed as the literary feature corresponding to the text type in the text information to be processed, which is a literary feature pre-learned by the first evaluation model in the training process of the first evaluation model in the above embodiment.

The first evaluation result is a value of 0-1. When the value is closer to 1, it indicates that the matching degree between the literary feature of the candidate piece of first sub-text information and the preset literary feature is higher. When the value is closer to 0, it indicates that the matching degree between the literary feature of the candidate piece of first sub-text information and the preset literary feature is lower.

In the training process in the above embodiment, the first evaluation model already has the capability of determining a matching degree between a literary feature of text information and a literary feature of a corresponding text type thereof. Therefore, in this embodiment, after extracting the literary feature of the candidate piece of first sub-text information, the first evaluation model may directly determine the matching degree between the literary feature of the candidate piece of first sub-text information and the literary feature corresponding to its text type, and the matching degree is used as the first evaluation result. The manner of determining the first sub-text information for outputting from the plurality of candidate pieces of first sub-text information based on the plurality of first evaluation results may include: determining the candidate piece of first sub-text information with the greatest first evaluation result as the first sub-text information for outputting. In this embodiment, the first sub-text information for outputting is determined from the plurality of candidate pieces of first sub-text information based on the first evaluation model. The first sub-text information generated by the text information generation model can be optimized. Thus, the quality of the first sub-text information is improved, and the quality of the target text information is further improved.

Exemplarily, assuming that the text type contained in the text information to be processed is a seven-character regulated verse, the text information to be processed is input to the text information generation model corresponding to the seven-character regulated verse to generate a plurality of candidate pieces of first sub-text information (first line) of a type of the seven-character regulated verse; and then the plurality of candidate pieces of first sub-text information are input to the first evaluation model corresponding to the seven-character regulated verse to select the final first sub-text information.

Optionally, the i-th sub-text information of the target text information is determined by the following steps: splicing the first sub-text information to the (i−1)-th sub-text information in a preset order to obtain spliced text information; inputting the text information to be processed and the spliced text information to the text information generation model, extracting, by the text information generation model, the semantic feature of the text information to be processed and a literary feature of the spliced text information, and obtaining a plurality of candidate pieces of i-th sub-text information for outputting according to the semantic feature of the text information to be processed and the literary feature of the spliced text information; inputting the plurality of candidate pieces of i-th sub-text information to the first evaluation model, separately, extracting, by the first evaluation model, literary feature of each candidate piece of i-th sub-text information, separately, obtaining a plurality of second evaluation results according to the literary feature of each candidate piece of i-th sub-text information, and determining the i-th sub-text information for outputting from the plurality of candidate pieces of i-th sub-text information based on the plurality of second evaluation results.

The second evaluation result is used for reflecting a matching degree between the literary feature of the candidate piece of i-th sub-text information and a preset literary feature corresponding to the text information to be processed; and the literary feature is used for reflecting a semantic feature and/or a literary rule feature of the candidate piece of i-th sub-text information.

The second evaluation result is a value of 0-1. When the value is closer to 1, it indicates that the matching degree between the literary feature of the candidate piece of i-th sub-text information and the preset literary feature is higher. When the value is closer to 0, it indicates that the matching degree between the literary feature of the candidate piece of i-th sub-text information and the preset literary feature is lower.

The manner of splicing the first sub-text information to the (i−1)-th sub-text information in the preset order may be splicing from front to back in a generation order. Exemplarily, the spliced text information may be expressed as: [first sub-text information, second sub-text information, . . . , (i−1)-th sub-text information].

In the training process in the above embodiment, the first evaluation model already has the capability of determining a matching degree between a literary feature of text information and a literary feature of a corresponding text type thereof. Therefore, in this embodiment, after extracting the literary feature of the candidate piece of i-th sub-text information, the first evaluation model may directly determine the matching degree between the literary feature of the candidate piece of i-th sub-text information and the literary feature corresponding to its text type, and the matching degree is used as the second evaluation result. The manner of determining the i-th sub-text information for outputting from the plurality of candidate pieces of i-th sub-text information based on the plurality of second evaluation results may include: determining the candidate piece of i-th sub-text information with the greatest second evaluation result as the i-th sub-text information for outputting. In this embodiment, the i-th sub-text information for outputting is determined from the plurality of candidate pieces of i-th sub-text information based on the first evaluation model. The i-th sub-text information generated by the text information generation model can be optimized. Thus, the quality of the i-th sub-text information is improved, and the quality of the target text information is further improved.

Exemplarily, assuming that the text type contained in the text information to be processed is a seven-character regulated verse, the text information to be processed and the generated first to (i−1)-th sub-text information are input to the text information generation model corresponding to the seven-character regulated verse to generate a plurality of candidate pieces of i-th sub-text information (i-th line) of a type of the seven-character regulated verse; and then the plurality of candidate pieces of i-th sub-text information are input to the first evaluation model corresponding to the seven-character regulated verse to select the final i-th sub-text information.

Optionally, the text generation method further includes the following steps: after generating the N pieces of sub-text information, splicing the N pieces of sub-text information in a preset order to obtain candidate text information; inputting the candidate text information to the second evaluation model, extracting, by the second evaluation model, a literary feature of the candidate text information, and obtaining a third evaluation result according to the literary feature of the candidate text information, and determining whether the candidate text information meets a preset condition according to the third evaluation result; and in response to the candidate text information meeting the preset condition, determining the candidate text information as output target text information.

The third evaluation result is used for reflecting a matching degree between the literary feature of the candidate text information and a preset literary feature corresponding to the text information to be processed; and the literary feature is used for reflecting a semantic feature and/or a literary rule feature of the candidate text information.

The preset literary feature corresponding to the text information to be processed may be understood as the literary feature corresponding to the text type in the text information to be processed, which is a literary feature pre-learned by the second evaluation model in the training process of the second evaluation model in the above embodiment.

The third evaluation result is a value of 0-1. When the value is closer to 1, it indicates that the matching degree between the literary feature of the candidate text information and the preset literary feature is higher. When the value is closer to 0, it indicates that the matching degree between the literary feature of the candidate text information and the preset literary feature is lower.

In the training process in the above embodiment, the second evaluation model already has the capability of determining a matching degree between a literary feature of text information and a literary feature of a corresponding text type thereof. Therefore, in this embodiment, after extracting the literary feature of the candidate text information, the second evaluation model may directly determine the matching degree between the literary feature of the candidate text information and the literary feature corresponding to its text type, and the matching degree is used as the third evaluation result. The manner of determining whether the candidate text information meets the preset condition according to the third evaluation result may include: determining whether the third evaluation result exceeds a set threshold; if yes, the candidate text information meets the preset condition; and if no, the candidate text does not meet the preset condition. The set threshold may be set to any value of 0.8-1. If the candidate text information meets the preset condition, the candidate text information is determined as the output target text information. If the candidate text information does not meet the preset condition, the second evaluation model may output prompt information such that the text information to be processed is adjusted based on the prompt information, and the operation of inputting the text information to be processed to the text generation model to obtain the target text information corresponding to the text information to be processed is performed again. In this embodiment, the text information formed by splicing the N pieces of sub-text information is evaluated based on the second evaluation model. The text information can be optimized as a whole. Thus, the overall quality of the target text information can be improved.

Exemplarily, assuming that the text type contained in the text information to be processed is a seven-character regulated verse, the candidate text information formed by splicing the N pieces of sub-text information is input to the second evaluation model corresponding to the seven-character regulated verse to evaluate whether the candidate text information meets the preset condition.

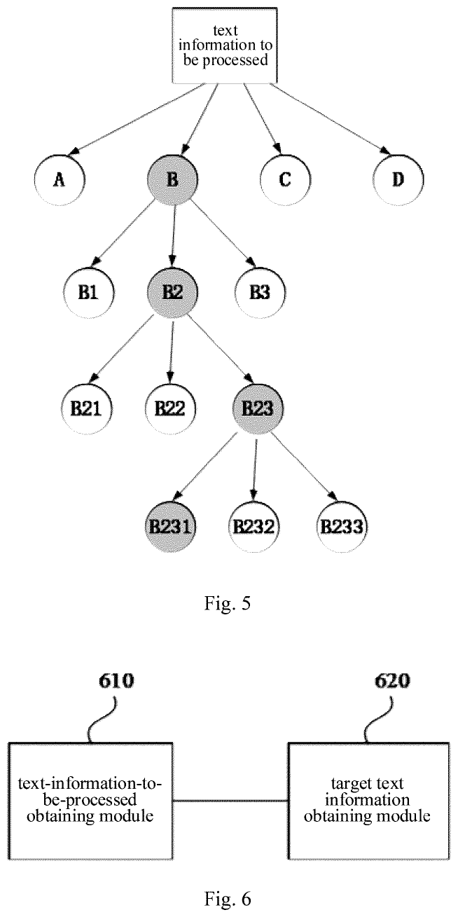

Exemplarily, on the basis of the above embodiments, FIG. 5 is a diagram illustrating an example of the text generation process in this embodiment. Taking a seven-character quatrain as an example, as shown in FIG. 5, the text information to be processed is input to the text information generation model to obtain four first lines, which are denoted as A, B, C and D, respectively, and B is selected from A, B, C and D as the final first line based on the first evaluation model. The text information to be processed and B are input to the text information generation model to continuously generate three second lines, which are denoted as B1, B2 and B3, respectively, and B2 is selected from B1, B2 and B3 as the final second line based on the first evaluation model. The text information to be processed and B-B2 are input to the text information generation model to continuously generate three third lines, which are denoted as B21, B22 and B23, respectively, and B23 is selected from B21, B22 and B23 as the final third line based on the first evaluation model. The text information to be processed and B-B2-B23 are input to the text information generation model to continuously generate three fourth lines, which are denoted as B231, B232 and B233, respectively, and B231 is selected from B231, B232 and B233 as the final fourth line based on the first evaluation model. Finally, B-B2-B23-B231 is evaluated based on the second evaluation model to determine whether it meets the preset condition, and if it meets the preset condition, the final target text information is determined as B-B2-B23-B231.

The technical solution of this embodiment includes: obtaining text information to be processed; and inputting the text information to be processed to a text generation model to obtain target text information corresponding to the text information to be processed, the target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information; first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N. According to the text generation method provided by the embodiments of the present disclosure, in the process of generating a text based on the text generation model, the generated sub-text information and the text information to be processed are input to the text generation model to obtain next sub-text information, which can not only improve the generation quality of the text, but also improve the generation efficiency.

FIG. 6 is a structural schematic diagram of a text generation apparatus provided by embodiments of the present disclosure. As shown in FIG. 6, the text generation apparatus includes:

a text-information-to-be-processed obtaining module 610 configured to obtain text information to be processed; and

a target text information obtaining module 620 configured to input the text information to be processed to a text generation model to obtain target text information corresponding to the text information to be processed, the target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;

first sub-text information of the target text information is determined by the text generation model according to a semantic feature of the text information be processed; and i-th sub-text information of the target text information is determined by the text generation model according to literary features of the first sub-text information to (i−1)-th sub-text information, and 1<i≤N.

Optionally, the text generation model includes a text information generation model, a first evaluation model, and a second evaluation model.

Optionally, the target text information obtaining module 620 includes a first sub-text information generation unit configured to:

input the text information to be processed to the text information generation model, extract, by the text information generation model, the semantic feature of the text information to be processed, and obtain a plurality of candidate pieces of first sub-text information for outputting according to the semantic feature of the text information to be processed;

input the plurality of candidate pieces of first sub-text information to the first evaluation model, separately, extract, by the first evaluation model, literary feature of each candidate piece of first sub-text information separately, and obtain a plurality of first evaluation results according to the literary feature of each candidate piece of first sub-text information, and determine the first sub-text information for outputting from the plurality of candidate pieces of first sub-text information based on the plurality of first evaluation results, the first evaluation result is used for reflecting a matching degree between the literary feature of the candidate piece of first sub-text information and a preset literary feature corresponding to the text information to be processed; and the literary feature is used for reflecting a semantic feature and/or a literary rule feature of the candidate piece of first sub-text information.

Optionally, the target text information obtaining module 620 includes an i-th sub-text information generation unit configured to:
splice the first sub-text information to the (i−1)-th sub-text information in a preset order to obtain spliced text information;
input the text information to be processed and the spliced text information to the text information generation model, extract, by the text information generation model, the semantic feature of the text information to be processed and a literary feature of the spliced text information, and obtain a plurality of candidate pieces of i-th sub-text information for outputting according to the semantic feature of the text information to be processed and the literary feature of the spliced text information;
input the plurality of candidate pieces of i-th sub-text information to the first evaluation model, separately, extract, by the first evaluation model, literary feature of each candidate piece of i-th sub-text information, separately, obtain a plurality of second evaluation results according to the literary feature of each candidate piece of i-th sub-text information, and determine the i-th sub-text information for outputting from the plurality of candidate pieces of i-th sub-text information based on the plurality of second evaluation results, the second evaluation result is used for reflecting a matching degree between the literary feature of the candidate piece of i-th sub-text information and a preset literary feature corresponding to the text information to be processed; and the literary feature is used for reflecting a semantic feature and/or a literary rule feature of the candidate piece of i-th sub-text information.

Optionally, the target text information obtaining module 620 includes a target text information generation unit configured to:
after generating the N pieces of sub-text information, splice the N pieces of sub-text information in a preset order to obtain candidate text information;
input the candidate text information to the second evaluation model, extract, by the second evaluation model, a literary feature of the candidate text information, and obtain a third evaluation result according to the literary feature of the candidate text information, and determine whether the candidate text information meets a preset condition according to the third evaluation result; and in response to the candidate text information meeting the preset condition, determine the candidate text information as output target text information, the third evaluation result is used for reflecting a matching degree between the literary feature of the candidate text information and a preset literary feature corresponding to the text information to be processed; and the literary feature is used for reflecting a semantic feature and/or a literary rule feature of the candidate text information.

Optionally, the text generation apparatus further includes an evaluation model training module configured to:
obtain a first initial model which is pre-trained;
obtain a first text information set, each piece of first text information in the first text information set carries a real evaluation result;
train the first initial model with respect to a first evaluation task based on the first text information set to obtain the first evaluation model, the first evaluation task is a task of evaluating sub-text information; and
train the first initial model with respect to a second evaluation task based on the first text information set to obtain the second evaluation model, the second evaluation task is a task of evaluating text information.

Optionally, the evaluation model training module includes a first evaluation model training unit configured to:
split each piece of first text information in the first text information set to obtain a first sub-text information set;
obtain a real evaluation sub-result set corresponding to the first sub-text information set;
input the sub-text information set to the first initial model to obtain a predicted evaluation sub-result set, each predicted evaluation sub-result in the predicted evaluation sub-result set is an evaluation result predicted by the first initial model for each piece of sub-text information; and
train the first initial model based on the predicted evaluation sub-result set and the real evaluation sub-result set to obtain the first evaluation model.

Optionally, the evaluation model training module includes a second evaluation model training unit configured to:
input each piece of first text information in the first text information set to the first initial model to obtain a predicted evaluation result set, each predicted evaluation result in the predicted evaluation result set is an evaluation result predicted by the first initial model for each piece of first text information; and
train the first initial model based on the predicted evaluation result set and a real evaluation result set to obtain the second evaluation model.

Optionally, the text generation apparatus further includes a text information generation model training module configured to:
obtain a second initial model which is pre-trained;
obtain a text-information-to-be-processed set and a corresponding second text information set thereof;
split each piece of second text information in the second text information set to obtain a second sub-text information set; and
train the second initial model based on the text-information-to-be-processed set and the second sub-text information to obtain the text information generation model.

Optionally, the literary rule feature includes a literary format feature and/or a literary rhythm feature.

The text generation apparatus provided by the embodiments of the present disclosure may perform the text generation method provided by any embodiment of the present disclosure and has corresponding functional modules for performing the text generation method and corresponding beneficial effects.

It needs to be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

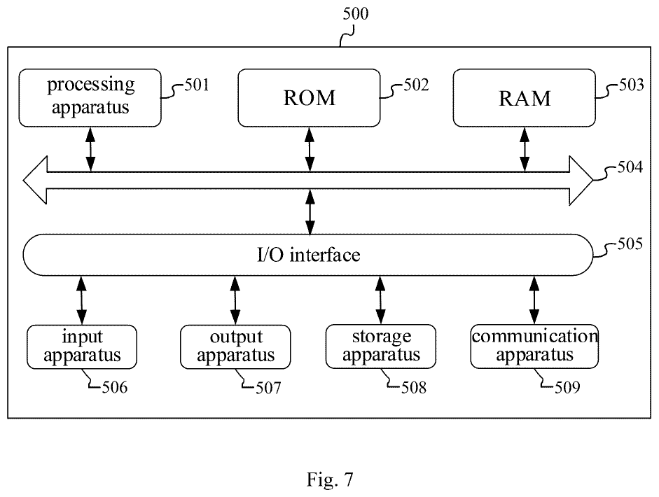

FIG. 7 is a structural schematic diagram of an electronic device provided by embodiments of the present disclosure. Referring to FIG. 7, FIG. 7 illustrates a schematic structural diagram of an electronic device (e.g. terminal device or server) 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 7 is merely an example, and should not pose any limitation to the functions and the range of use of the embodiments of the present disclosure.

As shown in FIG. 7, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 7 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of the messages or information exchanged between multiple apparatuses in the embodiments of the present disclosure are only for illustrative purposes, and are not used to limit the scope of these messages or information.

The electronic device provided in the embodiments of the present disclosure and the text generation method provided in the above embodiments belong to the same inventive concept. The technical details not fully described in this embodiment can be referred to the above embodiments, and this embodiment has the same beneficial effects as the above embodiments.

The embodiments of the present disclosure provide a computer storage medium on which a computer program is stored, and the program, when is executed by a processor, implements the text generation method provided in the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that may be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local region network (LAN), a wide region network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above-mentioned method of the present disclosure.

The above-mentioned computer-readable medium carries one or more programs, and when the one or more programs are executed by the electronic device, the electronic device is caused to perform: obtaining text information to be processed; and inputting the text information to be processed to a text generation model to obtain target text information corresponding to the text information to be processed, the target text information includes N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information; first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local region network (LAN) or a wide region network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, may be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, a first obtaining unit may also be described as a “unit for obtaining at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A text generation method, comprising:
obtaining text information to be processed; and
inputting the text information to be processed to a text generation model to obtain target text information corresponding to the text information to be processed, wherein the target text information comprises N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;
wherein first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

2. The text generation method according to claim 1, wherein the text generation model comprises a text information generation model, a first evaluation model, and a second evaluation model.

3. The text generation method according to claim 2, wherein the first sub-text information of the target text information is determined by the following steps:
inputting the text information to be processed to the text information generation model, extracting, by the text information generation model, the semantic feature of the text information to be processed, and obtaining a plurality of candidate pieces of first sub-text information for outputting according to the semantic feature of the text information to be processed;
inputting the plurality of candidate pieces of first sub-text information to the first evaluation model, separately, extracting, by the first evaluation model, literary feature of each candidate piece of first sub-text information separately, and obtaining a plurality of first evaluation results according to the literary feature of each candidate piece of first sub-text information, and determining the first sub-text information for outputting from the plurality of candidate pieces of first sub-text information based on the plurality of first evaluation results, wherein the first evaluation result is used for reflecting a matching degree between the literary feature of the candidate piece of first sub-text information and a preset literary feature corresponding to the text information to be processed; and the literary feature is used for reflecting a semantic feature and/or a literary rule feature of the candidate piece of first sub-text information.

4. The text generation method according to claim 1, wherein the i-th sub-text information of the target text information is determined by the following steps:
splicing the first sub-text information to the (i−1)-th sub-text information in a preset order to obtain spliced text information;
inputting the text information to be processed and the spliced text information to the text information generation model, extracting, by the text information generation model, the semantic feature of the text information to be processed and a literary feature of the spliced text information, and obtaining a plurality of candidate pieces of i-th sub-text information for outputting according to the semantic feature of the text information to be processed and the literary feature of the spliced text information;
inputting the plurality of candidate pieces of i-th sub-text information to the first evaluation model, separately, extracting, by the first evaluation model, literary feature of each candidate piece of i-th sub-text information, separately, obtaining a plurality of second evaluation results according to the literary feature of each candidate piece of i-th sub-text information, and determining the i-th sub-text information for outputting from the plurality of candidate pieces of i-th sub-text information based on the plurality of second evaluation results, wherein the second evaluation result is used for reflecting a matching degree between the literary feature of the candidate piece of i-th sub-text information and a preset literary feature corresponding to the text information to be processed; and the literary feature is used for reflecting a semantic feature and/or a literary rule feature of the candidate piece of i-th sub-text information.

5. The text generation method according to claim 2, further comprising:
after generating the N pieces of sub-text information, splicing the N pieces of sub-text information in a preset order to obtain candidate text information;
inputting the candidate text information to the second evaluation model, extracting, by the second evaluation model, a literary feature of the candidate text information, and obtaining a third evaluation result according to the literary feature of the candidate text information, and determining whether the candidate text information meets a preset condition according to the third evaluation result; and in response to the candidate text information meeting the preset condition, determining the candidate text information as output target text information, wherein the third evaluation result is used for reflecting a matching degree between the literary feature of the candidate text information and a preset literary feature corresponding to the text information to be processed; and the literary feature is used for reflecting a semantic feature and/or a literary rule feature of the candidate text information.

6. The text generation method according to claim 2, further comprising:
obtaining a first initial model which is pre-trained;
obtaining a first text information set, wherein each piece of first text information in the first text information set carries a real evaluation result;
training the first initial model with respect to a first evaluation task based on the first text information set to obtain the first evaluation model, wherein the first evaluation task is a task of evaluating sub-text information; and
training the first initial model with respect to a second evaluation task based on the first text information set to obtain the second evaluation model, wherein the second evaluation task is a task of evaluating text information.

7. The text generation method according to claim 6, wherein training the first initial model with respect to the first evaluation task based on the first text information set to obtain the first evaluation model comprises:
splitting each piece of first text information in the first text information set to obtain a first sub-text information set;
obtaining a real evaluation sub-result set corresponding to the first sub-text information set;
inputting the sub-text information set to the first initial model to obtain a predicted evaluation sub-result set, wherein each predicted evaluation sub-result in the predicted evaluation sub-result set is an evaluation result predicted by the first initial model for each piece of sub-text information; and
training the first initial model based on the predicted evaluation sub-result set and the real evaluation sub-result set to obtain the first evaluation model.

8. The text generation method according to claim 6, wherein training the first initial model with respect to the second evaluation task based on the first text information set to obtain the second evaluation model comprises:
inputting each piece of first text information in the first text information set to the first initial model to obtain a predicted evaluation result set, wherein each predicted evaluation result in the predicted evaluation result set is an evaluation result predicted by the first initial model for each piece of first text information; and
training the first initial model based on the predicted evaluation result set and a real evaluation result set to obtain the second evaluation model.

9. The text generation method according to claim 2, further comprising:
obtaining a second initial model which is pre-trained;
obtaining a text-information-to-be-processed set and a corresponding second text information set;
splitting each piece of second text information in the second text information set to obtain a second sub-text information set; and
training the second initial model based on the text-information-to-be-processed set and the second sub-text information to obtain the text information generation model.

10. The text generation method according to claim 1, wherein the literary rule feature comprises a literary format feature and/or a literary rhythm feature.

11. An electronic device, comprising:
one or more processors; and
a storage apparatus configured to store one or more programs,
wherein the one or more programs, when executed by the one or more processors, cause the one or more processors to implement:
obtaining text information to be processed; and
inputting the text information to be processed to a text generation model to obtain target text information corresponding to the text information to be processed, wherein the target text information comprises N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;
wherein first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

12. The electronic device according to claim 11, wherein the text generation model comprises a text information generation model, a first evaluation model, and a second evaluation model.

13. The electronic device according to claim 12, wherein the first sub-text information of the target text information is determined by the following steps:
inputting the text information to be processed to the text information generation model, extracting, by the text information generation model, the semantic feature of the text information to be processed, and obtaining a plurality of candidate pieces of first sub-text information for outputting according to the semantic feature of the text information to be processed;
inputting the plurality of candidate pieces of first sub-text information to the first evaluation model, separately, extracting, by the first evaluation model, literary feature of each candidate piece of first sub-text information separately, and obtaining a plurality of first evaluation results according to the literary feature of each candidate piece of first sub-text information, and determining the first sub-text information for outputting from the plurality of candidate pieces of first sub-text information based on the plurality of first evaluation results, wherein the first evaluation result is used for reflecting a matching degree between the literary feature of the candidate piece of first sub-text information and a preset literary feature corresponding to the text information to be processed; and the literary feature is used for reflecting a semantic feature and/or a literary rule feature of the candidate piece of first sub-text information.

14. The electronic device according to claim 11, wherein the i-th sub-text information of the target text information is determined by the following steps:
splicing the first sub-text information to the (i−1)-th sub-text information in a preset order to obtain spliced text information;
inputting the text information to be processed and the spliced text information to the text information generation model, extracting, by the text information generation model, the semantic feature of the text information to be processed and a literary feature of the spliced text information, and obtaining a plurality of candidate pieces of i-th sub-text information for outputting according to the semantic feature of the text information to be processed and the literary feature of the spliced text information;
inputting the plurality of candidate pieces of i-th sub-text information to the first evaluation model, separately, extracting, by the first evaluation model, literary feature of each candidate piece of i-th sub-text information, separately, obtaining a plurality of second evaluation results according to the literary feature of each candidate piece of i-th sub-text information, and determining the i-th sub-text information for outputting from the plurality of candidate pieces of i-th sub-text information based on the plurality of second evaluation results, wherein the second evaluation result is used for reflecting a matching degree between the literary feature of the candidate piece of i-th sub-text information and a preset literary feature corresponding to the text information to be processed; and the literary feature is used for reflecting a semantic feature and/or a literary rule feature of the candidate piece of i-th sub-text information.

15. The electronic device according to claim 11, wherein the literary rule feature comprises a literary format feature and/or a literary rhythm feature.

16. A storage medium comprising computer-executable instructions, wherein the computer-executable instructions, when executed by a computer processor, are configured to perform
obtaining text information to be processed; and
inputting the text information to be processed to a text generation model to obtain target text information corresponding to the text information to be processed, wherein the target text information comprises N pieces of sub-text information, and the target text information is determined by splicing the N pieces of sub-text information in a preset order, with a literary feature of the target text information meeting a preset condition, and the literary feature is used for reflecting a semantic feature and/or a literary rule feature of the target text information;
wherein first sub-text information of the target text information is determined by the text generation model according to a semantic feature of the text information to be processed; and i-th sub-text information of the target text information is determined by the text generation model according to literary features of the first sub-text information to (i−1)-th sub-text information, and 1<i≤N.

17. The storage medium according to claim 16, wherein the text generation model comprises a text information generation model, a first evaluation model, and a second evaluation model.

18. The storage medium according to claim 17, wherein the first sub-text information of the target text information is determined by the following steps:
inputting the text information to be processed to the text information generation model, extracting, by the text information generation model, the semantic feature of the text information to be processed, and obtaining a plurality of candidate pieces of first sub-text information for outputting according to the semantic feature of the text information to be processed;
inputting the plurality of candidate pieces of first sub-text information to the first evaluation model, separately, extracting, by the first evaluation model, literary feature of each candidate piece of first sub-text information separately, and obtaining a plurality of first evaluation results according to the literary feature of each candidate piece of first sub-text information, and determining the first sub-text information for outputting from the plurality of candidate pieces of first sub-text information based on the plurality of first evaluation results, wherein the first evaluation result is used for reflecting a matching degree between the literary feature of the candidate piece of first sub-text information and a preset literary feature corresponding to the text information to be processed; and the literary feature is used for reflecting a semantic feature and/or a literary rule feature of the candidate piece of first sub-text information.

19. The storage medium according to claim 16, wherein the i-th sub-text information of the target text information is determined by the following steps:
splicing the first sub-text information to the (i−1)-th sub-text information in a preset order to obtain spliced text information;
inputting the text information to be processed and the spliced text information to the text information generation model, extracting, by the text information generation model, the semantic feature of the text information to be processed and a literary feature of the spliced text information, and obtaining a plurality of candidate pieces of i-th sub-text information for outputting according to the semantic feature of the text information to be processed and the literary feature of the spliced text information;
inputting the plurality of candidate pieces of i-th sub-text information to the first evaluation model, separately, extracting, by the first evaluation model, literary feature of each candidate piece of i-th sub-text information, separately, obtaining a plurality of second evaluation results according to the literary feature of each candidate piece of i-th sub-text information, and determining the i-th sub-text information for outputting from the plurality of candidate pieces of i-th sub-text information based on the plurality of second evaluation results, wherein the second evaluation result is used for reflecting a matching degree between the literary feature of the candidate piece of i-th sub-text information and a preset literary feature corresponding to the text information to be processed; and the literary feature is used for reflecting a semantic feature and/or a literary rule feature of the candidate piece of i-th sub-text information.

20. The storage medium according to claim 16, wherein the literary rule feature comprises a literary format feature and/or a literary rhythm feature.
